(19) United States
(12) Patent Application Publication
(10) Pub. No.: US 2025/0095451 A1
(43) Pub. Date: Mar. 20, 2025

(54) METHOD AND APPARATUS OF PLAYING A GAME USING THE ALPHABETIC LETTERS

(71) Applicant: Raphael Mourad, Toronto (CA)

(72) Inventor: Raphael Mourad, Toronto (CA)

(21) Appl. No.: 18/968,183

(22) Filed: Dec. 4, 2024

Related U.S. Application Data
(63) Continuation of application No. 16/350,333, filed on Nov. 5, 2018, now Pat. No. 12,217,573.
(60) Provisional application No. 62/708,081, filed on Dec. 1, 2017.

(51) Int. Cl. G07F 17/32; G07F 17/34

(52) U.S. Cl. CPC G07F 17/3288; G07F 17/3211; G07F 17/3225; G07F 17/3293; G07F 17/3262; G07F 17/34

(57) ABSTRACT

A gaming apparatus includes a data processor implementing a random number generator. The apparatus also includes a database storing libraries with a plurality of sets. Each set includes C letters of an alphabet. The apparatus further includes a user-operable keypad to input a user's choice of a unique combination or permutation of letters and a user-operable trigger causing the data processor to randomly select and display in sequence one or more of the letters to form an outcome. All the letters have an equal chance to be selected and displayed.

### CROSS REFERENCE TO RELATED APPLICATIONS

This application is a Continuation of U.S. patent application Ser. No. 16/350,333, filed Nov. 5, 2018, which claims priority from U.S. Provisional Patent Application Ser. No. 62/708,081, filed on Dec. 1, 2017, the entire content of all Related Applications being incorporated herein by reference.

### FIELD OF THE INVENTION

This invention relates to social or casino games using one or more sets of the 26 alphabetic letters.

### BACKGROUND ART

A wide variety of games are known in the gaming industry, including social games and games played at casinos. In general, these games are divided into two main categories; games of pure chance and games with a skill component. Games of pure chance include Yahtzee, Slot or Video Machines, Keno, Roulette, Craps, Baccarat, War, Sic Bo and the Big Wheel. Games with a skill component include Backgammon, Rummy, Canasta, BlackJack and Poker-type games. All these pure chance or skill component games, or variations of them, use set of numbers or symbols on dice, conventional cards, tiles or wheels. Players bet on a single outcome or on combinations of these numbers or symbols. Games that are using the alphabetic letters such as Scrabble, Words or Wheel of Fortune are considered as determined word puzzles that player or players attempt to solve them. In these games, players do not make any decision or place a wager but simply use their knowledge and skill to solve a word puzzle. This invention discloses a game of chance in which participants have the opportunity to make a decision, to place a wager, to explore the world of words and be exposed to a great learning experience. The advantageous games of the present disclosure provide games that can be played by players with substantial skill or experience or with almost no skill or experience in the playing of games of this type. The invention discloses a fair, honest and high integrity social or wagering game, that uses one or more sets (or decks) of the 26 alphabetic letters, provides fun, challenge and entertainment to people in social encountering and to casual players in gambling establishments.

### SUMMARY OF THE PRESENT DISCLOSURE

The present disclosure provides a new game “WORDY” that can be played at social encountering and in particular, in gaming establishments or casinos, either in table game setups or in single player slot/video machines or in multi-players electronic setups. The present disclosure provides the following advantageous advances to the field of games playing systems and methods: The game uses one or multiple sets (or decks) of the 26 alphabetic letters A to Z, and may include one or more wild letters, most preferably 1 to 10 sets in social encountering or in table games setups in casinos and an infinite number of sets in a slot/video machine or multi-players electronic setups. In the following, any letter will be interchangeably referred to as an entity, (as the letters can be displayed on reels of a slot/video machine, engraved on dice or tiles, printed on cards or on any other media) and to any combination of two or more letters as a “Hand” in social/Table games and as an “Outcome” in Machines. FIG. 1 shows seven entities, (letters printed on cards), that represent 2, 3 and 4 letter “Hands”. FIG. 2 shows a 2 and 3 letter “Outcomes” displayed on a slot machine. “Hands” or “Outcomes” are rated, compared and valued within an established Ranking system.

### BRIEF DESCRIPTION OF THE DRAWINGS

So the those having ordinary skill in the art to which the present disclosure pertains will more readily understand how to make and use the subject invention, exemplary embodiments will be described in detail herein below with reference to the drawings, wherein:

FIG. 1 is a display of letters on cards, showing 2, 3 and 4 letter “Hands”;

FIG. 2 is a display of letters on a slot/video machine, showing 2 and 3 letter “Outcomes”;

FIG. 3 is a Table showing a Ranking system for letters' combinations of “Hands” or “Outcomes”;

FIG. 4 is a Chart showing the Ranking system for letters' combinations of “Hands” or “Outcomes”;

FIG. 5 is a Table showing an established Library of 2-letter “Hands” using one set (deck) of letters;

FIG. 6 is a Chart showing the Library plan of 2-letter “Hands” using one set (deck) of letters;

FIG. 7 is a Table showing an established Library of 2-letter “Outcomes” using infinite sets of letters;

FIG. 8 is a Chart showing the Library plan of 2-letter “Outcomes” using infinite sets of letters;

FIG. 9 is a Table showing an established Library of 3-letter “Hands” using one set (deck) of letters;

FIG. 10 is a Chart showing the Library plan of 3-letter “Hands” using one set (deck) of letters;

FIG. 11 is a Table showing a Library plan of 3-letter “Outcomes” using infinite sets of letters;

FIG. 12 is a Chart showing the Library plan of 3-letter “Outcomes” using infinite sets of letters;

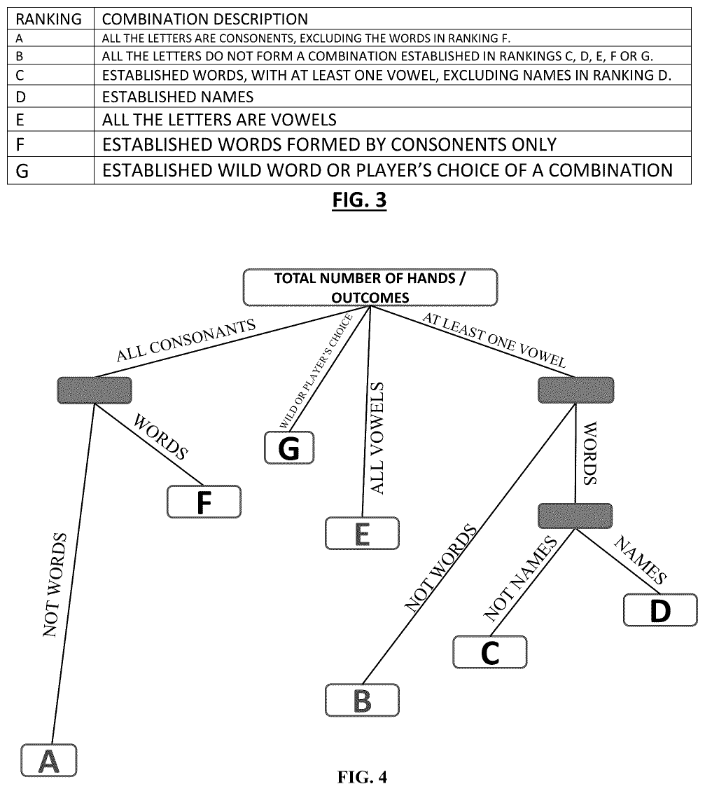

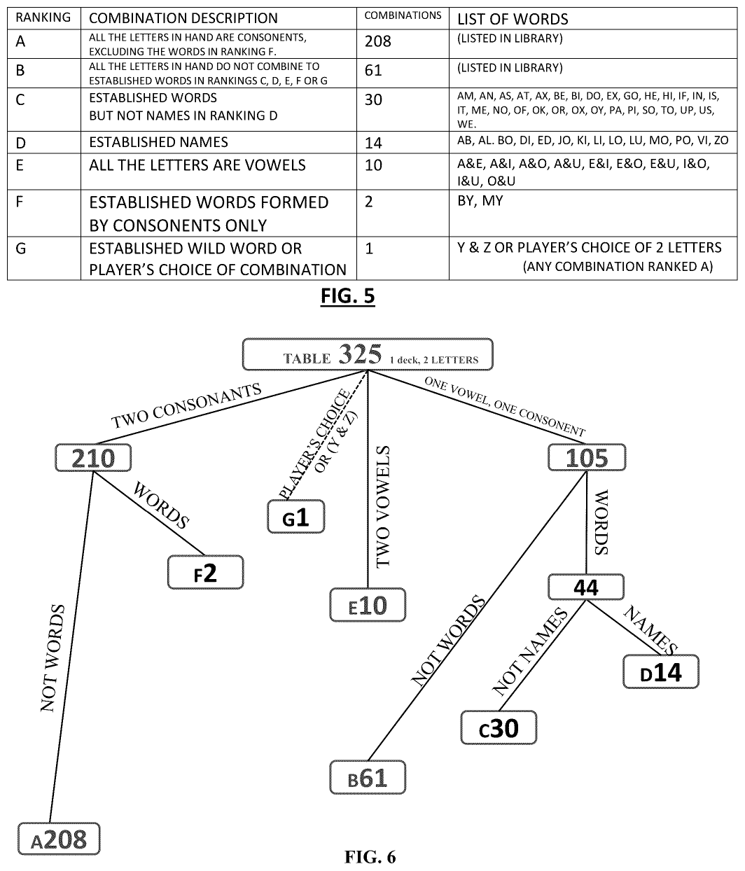

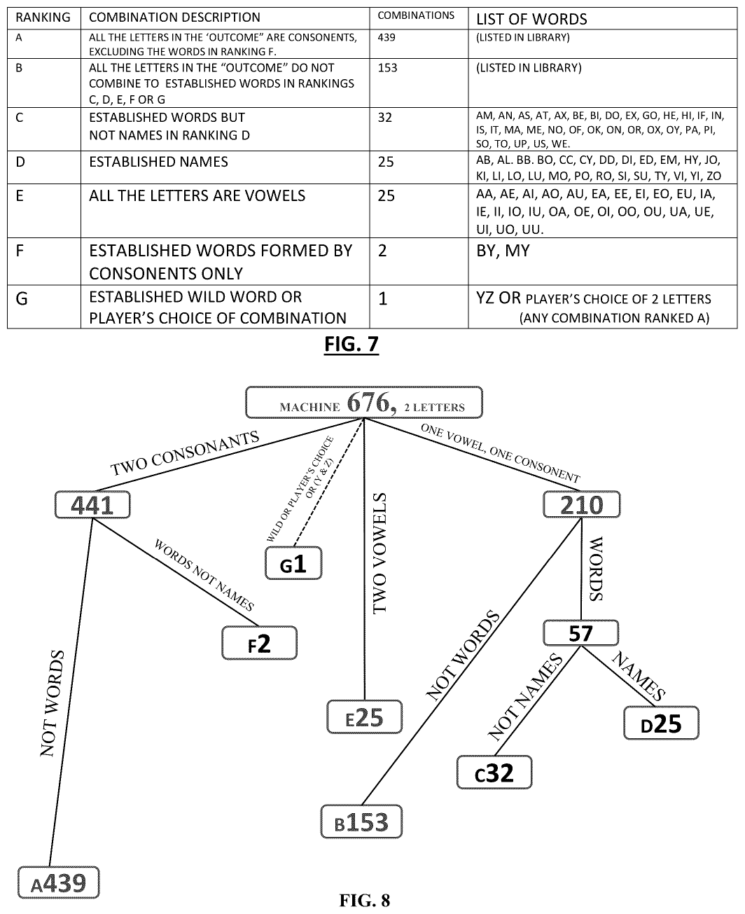

As an example of an established Ranking system, FIG. 3 and FIG. 4 give a Ranking system of “Hands” or “Outcomes” that applies to any number of sets of entities and to any number of letters. In this example, “Hands and “Outcomes” are ranked into 7 categories, A to G, from lowest to highest. For a specific number of letters, l, and a specific number of sets of entities, S, a library L is set up that includes all the combinations of the l letters and ranked within the said Ranking system. In the said Ranking system, a combination of letters that form an established wild combination (such as Y&Z, X,Y&Z, W,X,Y&Z) or a player's choice of letters (such as BB, SUE, LOVE) is ranked G; a combination of consonants only that form an established word in the respective Library, is ranked F; a combination of vowels only is ranked E; a combination of letters that form an established name in the respective Library, is ranked D; a combination of letters that form an established word in the respective Library, is ranked C; a combination of letters, that constitute of at least one vowel, that is listed in the respective Library, is ranked B and all the other combinations are ranked A. FIG. 5 and FIG. 6 provide the Library and Ranking of “Hands” associated with l=2, S=1 (2 letters combinations and a single set of entities) for social/table games. FIG. 7 and FIG. 8 provide the library and Ranking of “Outcomes” associated with l=2 and infinite number of sets of entities for machines or multi players electronic setups. Every “Hand” with 2 letters is uniquely defined and ranked in FIG. 5 and FIG. 6, and every “Outcome” of 2 letters is uniquely defined and ranked in FIG. 7 and FIG. 8. As noted, the “Hand” consisting of the combination of the two letters O and F is ranked C in FIG. 5, however, in FIG. 7, the “Outcome” OF is ranked C, while the “Outcome” FO is ranked B. The “Hand” consisting of the combination of the two letters B and Y is ranked F in FIG. 5, while in FIG. 7, the “Outcome” BY is ranked F while the “Outcome” YB is ranked A.

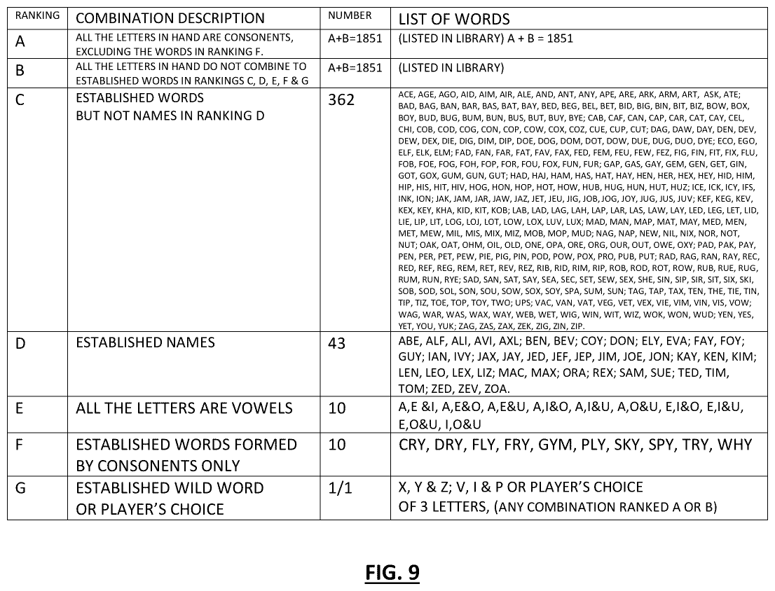

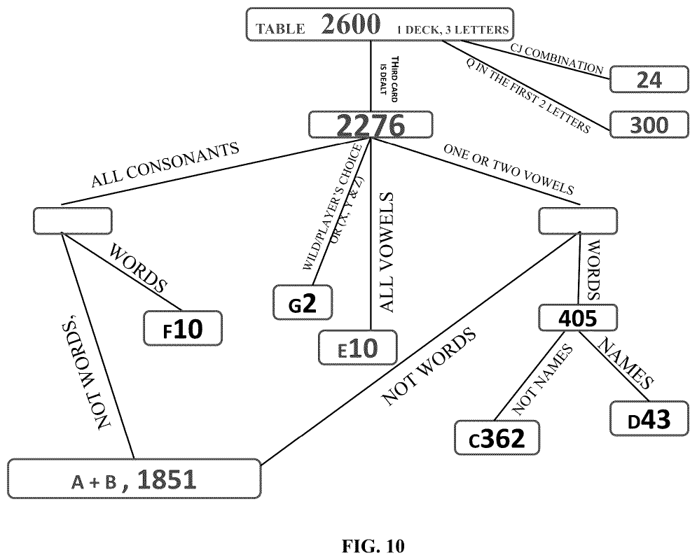

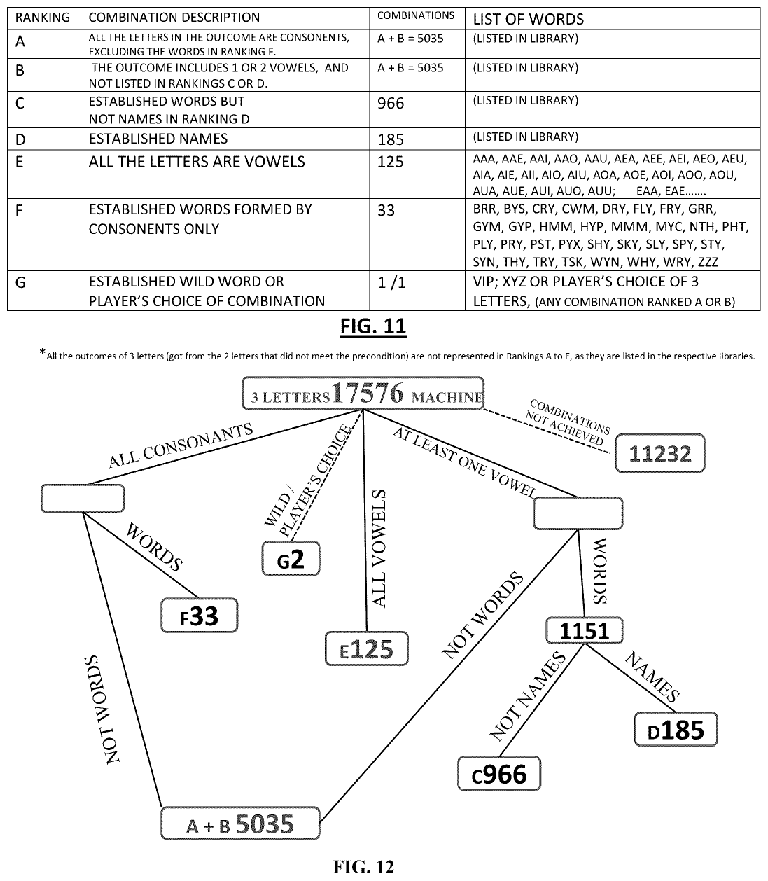

Similarly, FIG. 9 and FIG. 10 were derived and established for the three Letter “Hands” and FIG. 11 and FIG. 12 were derived and established for the three Letter “Outcomes”.

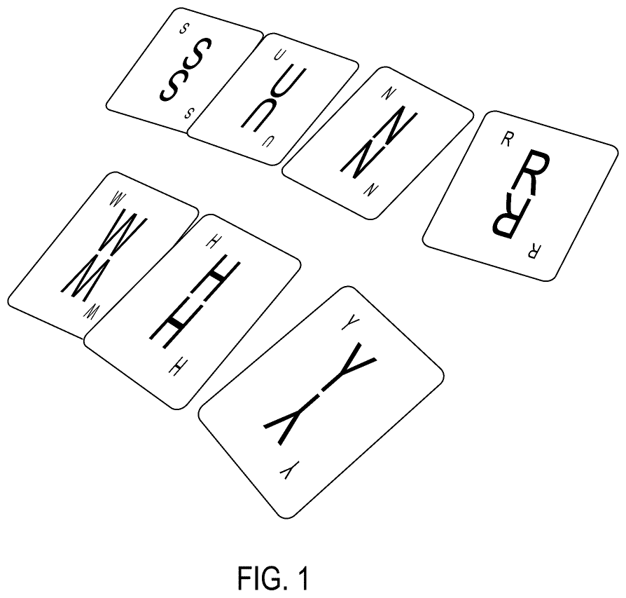

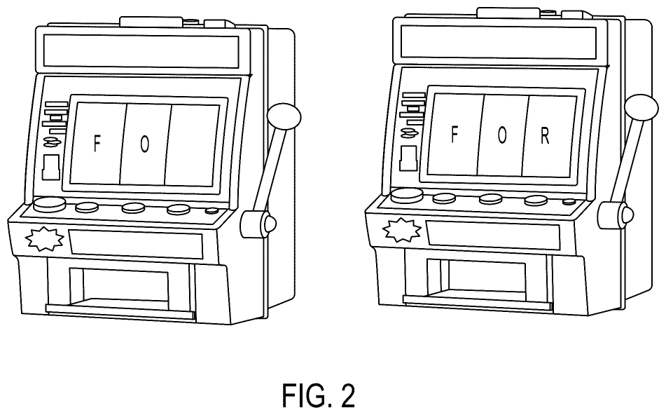

The “Hands” and “Outcomes” of FIG. 1 and FIG. 2 are as follow: the 2-letter “Hand”, that constitutes of the two letters S & U, is ranked C. The added letter N form together a 3-letter “Hand” (SUN) ranked C, and the added 4^{th} letter R form all together a 4-letter “Hand” (RUNS) is also ranked C. The 2-letter “Hand”, that constitutes of the two letters H & W, is ranked A, whereas the added letter Y form together a 3-letter “Hand” (WHY) ranked F. The “Outcome of the first 2-reels, FO, is ranked B, whereas the display of the letter R on the third reel, forms the “Outcome” FOR which is ranked C.

A different Ranking system or a refinement of the above Ranking system can also be applied. The refinement may include a ranking of the alphabetic letters (R is ranked higher than D, but ranked lower than Y) and a ranking of the “Hands” or “Outcomes” within any of the categories A to G. The 2-letter combinations O & R and I & S are both ranked C, but under the said refined Ranking system, the combination I & S is higher than the combination O & R, since S is ranked higher than R. The 3-letter combinations C, R, & Y and D, R & Y are both ranked F, but under the said refined ranking system the combination D, R & Y is higher than the combination C, R, & Y, since D is ranked higher than C.

The disclosure clearly passes the section 101 rejection imposed by the court in In Re Smith, 815F3d816, when dealing with a “conventional card game” on the basis that the claims defined an abstract idea analogous to the economic ideas considered in Alice and Bilski. There is nothing economic involved in the invention or in claims 1 and 13 as they do not define a wagering game or employ conventional cards. However, like all contests, such as board games like chess or checkers, or sporting events between teams or multiple parties such as races and poker games, wagers may be based on the result of the contest or of the game. The present invention is applied into three exemplary games; the game being played in social encounters, in gambling establishment, either in a table game setup or in a single or multi-player electronic system.

### DETAILED DESCRIPTION OF EXEMPLARY EMBODIMENTS

In an exemplary embodiment, the game “WORDY” can be played at social encounters. At the start of round of play, each participant receives two or more entities and when in turn, a participant can dump, replace or add one or more entities, in trying to improve participant's “Hand” and establish a “Hand” that is highly rated. At any time, and in accordance to the game rules, each participant can stop the round of play by calling it and the winner of the round of play is the one that has the highest “Hand” value. When the round of play is stopped, all the participants “Hands” are compared and a winner is declared. When the comparison is done between two “Hands” of equal number of cards, the comparison is strictly done using the ranking in FIG. 3 or alternatively by using a refined or different Ranking system. When the two “Hands” have different number of entities, then the higher ranking hand is established in accordance to the rules of the game. A two letter “Hand” can be rated lower or higher than a three letter “Hand”, pending on the ranking system and the rules of play. Using the Libraries and Ranking system given in FIG. 5 and FIG. 9 for 2 and 3 letters respectively, and the payouts provided in Table 2 and Table 3 one may conclude the following; “2 Letter Hand” ranked G or F is higher than “3 Letter Hand” ranked D or less, “2 Letter Hand” ranked E or D is higher than “3 Letter Hand” ranked C or less, and “2 Letter Hand” ranked C or B is higher than “3 Letter Hand” ranked less than C. As an example, the combination of the two letters B and Y (“2 Letter Hand” ranked F) is higher than the combination of the three letters F, O and R, (“3 Letter Hand” ranked C) but lower than the combination C, R and Y (“3 Letter Hand” ranked F).

Two exemplary embodiments of the game “Wordy”, when played in gaming establishments or casinos, in table game and multi players and slot/video machine setups, are given below.

### Table Game Setup

In table game setups, the game may have between two and three stages in a round of play. At the start of each round, players place one main wager within the minimum and maximum main wager limits agreed upon or set up by the casino, and one or more side bets, most preferably two to three, each within the minimum and maximum side bet limits agreed upon or set up by the casino.

After wagers have been placed, each player and the dealer receive two entities; the player's letters are facing up, and one of the dealer's letter faces down. The fate of the main wager is associated with the comparison of the player's and dealer's “2 letter Hands” values. The fate of each side bet is associated with the player's “Hand” ranking and value only. After the main wager and the first side bet are settled, player receives a third additional entity if player has placed at the start of the play a second side bet, and if a predetermined condition on the first player's 2 entities is met. If the player has placed a second side bet but the condition is not met, then all wagers beyond the first side bet are totally or partially credited back to the player and the round of play ends.

In any stage of the game, a player who has placed a side bet beyond that stage of the game, and the predetermined condition is met in that stage, player receives an additional entity. If the player has not placed a side bet beyond that stage or the predetermined condition is not met, then the round of game ends, and wagers beyond the said stage, if any, are totally or partially credited back to the player.

In a preferred embodiment, a single set of entities is used, wild letters are not included, and each round consists of two stages; each player places one main wager and two side bets. “Hands” in the first stage consist of two letters combinations and “Hands” in the second stage consist of three letters combinations. The two or three letters combinations are ranked into 7 categories, A to G, from lowest to highest, as provided in FIG. 5 and FIG. 9 respectively. For the first side bet, a 2 letter “Hand” is a winning “Hand” if its ranking is B or higher, and for the second side bet, a 3 letter “Hand” is a winning “Hand” if it is ranked C or higher. The predetermined condition set in this preferred embodiment, is that the player must have a chance to form a winning “3 card hand” by withdrawing an additional third entity. This condition is met unless the 2 letter “Hand” includes the letter Q or consists of the letters C and J.

The fate of the main wager and of the two side bets are assessed as follows:

Players are given the choice, after seeing the dealer's face up letter, whether to lose the main wager and not to play against the dealer, or to double (or triple) the main wager and to play against the dealer. The dealer qualifies to play against the players if dealer's 2 letters “Hand” is rated B or better. A player most likely will decide to play the main wager unless the dealer's face up letter is a vowel and player's “Hand” is ranked A. Player places, therefore, one unit wager in 12.25% of the time (5/26×207/325) and 2 or 3 units in 87.75% of the times, resulting into an average wager of 1.8775 unit and 2.755 unit for doubling and tripling respectively. If the dealer is not qualified to play, (dealer's hand is 2 consonants and not the combinations B & Y or M & Y), dealer returns the main wager and all the adds on to the player. If the dealer is qualified to play, then the dealer compares the ranking of the dealer's “Hand” to the player's “Hand”; If the dealer's “Hand” ranks higher than the player's “Hand”, dealer collects the player's main wager and the adds on; if the dealer's “Hand” ranks equally to the player's “Hand”, it is a push, and if the dealer's “Hand” ranks lower than the player's “Hand”, dealer pays the main wager and the adds on in accordance to Table 1. Using the payouts given in Table 1 below, the Casino Advantage, CA, is calculated at 5.14% if player doubles the main wager to play, and 1.58% if player triples the main wager to play.

TABLE 1

| TWO LETTER PLAYER'S HAND | |
|---|---|
| RATED AGAINST DEALER'S HAND | PAYOUT |
| PUSH, SAME RANKING | 0 TO 1 |
| ONE RANKING HIGHER | 8 TO 1 |
| TWO RANKINGS HIGHER | 15 TO 1 |
| THREE RANKINGS HIGHER | 50 TO 1 |
| FOUR RANKINGS HIGHER | 100 TO 1 |
| FIVE RANKINGS HIGHER | 500 TO 1 |
| DOUBLE/TRIPPLE | CA = 5.14%/1.58% |

HOUSE QUALIFIES TO PLAY IF “HOUSE HAND” IS RATED B OR HIGHER. PLAYER PLAYS IF DOUBLES OR TRIPPLES WAGER

When multi sets of entities are used, the method of play, Libraries, the payout schedule and the Casino Advantage could be different from the above. Also, if the dealer face up letter is Y or Z, then players may be offered an insurance bet that could pay 22 to 1, if dealer “Hand” ends with the wild combination Y & Z.

After the main wager is settled, the dealer places the House two entities in the stack. The fate of the player's first side bet is settled according to Table 2 below. Using the payouts given in Table 2, the Hit Frequency, HF, is calculated at 36% and the Casino Advantage, CA, is calculated at 2.46%.

TABLE 2

| PLAYER'S TWO LETTER | | OUTCOME/PAYOUT | |
|---|---|---|---|
| HAND | | TABLE SETUP | |
| A. | TWO CONSONANTS | 208 | −1/LOSS |
| | COMBINATIONS (BY | | |
| | AND MY ARE EXCLUDED) | | |
| B. | ONE VOWEL AND ONE | 61 | 1 TO 1 |
| | CONSONANT, NOT AN | | |
| | ESTABLISHED WORD | | |
| C. | AN ESTABLISHED WORD | 30 | 3 TO 2 |
| | BUT NOT A NAME | | |
| D. | AN ESTABLISHED NAME | 14 | 2 TO 1 |
| E. | TWO VOWELS | 10 | 3 TO 1 |
| F. | THE WILD WORDS BY OR MY | 2 | 10 TO 1 |
| G. | PLAYER'S INITIALS OR | 1 | 15 TO 1 |

| | |
|---|---|
| CHOICE OF ANY 2 LETTERS | |
| OR Y&Z | |
| | TOTAL OF 325, HF = 36%, |
| | CA = 2.46% |

In the second stage of the game, each player, whose 2 letter “Hand” in the first stage contains the letter Q or are the combination of the letters C and J, pushes on the second side bet and the round of play ends (since the pre-determined condition is not met). If the two letters “Hand” in the first stage do not contain the letter Q and are not the combination C and J, then player receives one more entity. The fate of the second side bet is associated with the player's 3 letter “Hand” value. The objective of the second stage of the game is to use all the three letter combination to fall within the best group rating, A to G. Player's “Hand” wins if it ranks C or better and loses if it ranks A or B. Using the ranking system and payout schedules of Table 3 below, HF is calculated at 29% and CA is calculated at 3.1%.

TABLE 3

| THREE LETTER HAND | |
|---|---|
| COMBINATIONS RATED | |
| FROM A TO G, WORST | OUTCOME/PAYOUT |
| TO BETTER | TABLE SETUP |

| | | |
|---|---|---|
| A & B | 1849 | −1/LOSS |
| ONE OF THE 2 LETTERS | 324 | PUSH |
| IS Q OR CJ COMBINATION | | |
| C | 362 | 2 TO 1 |
| D | 43 | 8 TO 1 |
| E | 10 | 25 TO 1 |
| F | 10 | 25 TO 1 |
| G | 2 | 100 TO 1 |

TOTAL OF 3276 HF = 29%,
CA = 3.1%

The round of the game continues until the last placed wager, or until the predetermined condition is not met.

### Multi Players and Slot/Video Machine Electronic Setups

Instead of physical entities, a live dealer, hardcopies of Ranking systems, lists of combinations of letters and their classification into the Ranking system, method and rules of play used in social and table games setups, an apparatus that includes a display, stored libraries, method and rules of play and a computer processor are used to simulate and play the game “Wordy” in electronic setups.

The apparatus stores a large number of sets of the 26 alphabetic letters, Libraries of all possible “Hands” and “Outcomes”, each library is associated with combinations of a fixed number of the alphabetic letters, includes a Ranking system that applies to each and all of the stored libraries, establishes electronic files associated with the stored libraries in which each “Hand” or “Outcome” is uniquely ranked within the established Ranking system.

The apparatus accepts wagers, and randomly selects and displays entities to form “Hands” or “Outcomes”. The computer processor ranks and compares the “Hands” or “Outcomes” and establishes the fate of each wager in accordance to the methods of play and payouts schedules built in the computer. The following two preferred embodiments demonstrate the use of the apparatus in playing the game “Wordy”.

One embodiment includes a multi player electronic setup system and a computerized processor, with a video display of a dealer surrounded by multiplayer positions and terminals. The processor has means to accept one main wager from at least one player, randomly selects and displays two entities to the or each player and to the “House”. Player's letters are facing up whereas one of the House letter is facing down. The processor gives players the choice, after seeing the House face up letter, whether to lose the whole or a part of the main wager and not to play against the House, or to double (or triple) the main wager and to play against the House. The House qualifies to play against the players if the House's 2 letter “Hand” is ranked at a specified level or better. If the House is not qualified to play, House returns the main wager and all the adds-on to the player. If the House is qualified to play, then the processor compares the ranking of the House's “Hand” to the player's “Hand”; If the House's “Hand” rates higher than the player's “Hand”, processor collects the player's main wager and the adds-on; if the House's “Hand” rates equally to the player's “Hand”, it is a push, and if the House's “Hand” rates lower than the player's “Hand”, processor pays the main wager and the adds-on in accordance to a built in payout schedule.

Another preferred embodiment is the use of a slot/video machine with R reels or columns, R=>3 and accepts W independent multi wagers, W=>2. Each reel or column has or can display all the alphabetic letters. After placing the said W wagers, player pushes the spin button which triggers the first two reels or columns to spin and display an “Outcome” of two alphabetic letters. This outcome is associated with and determines the fate of the first wager. When the Library and the Ranking system given in FIG. 7 are built in the said machine, the processor may collect and pay the first wager in accordance to the payout schedule given in Table 4 below. In that case, HF is calculated at 35% and CA is calculated at 4.8%.

TABLE 4

| | |
|---|---|
| RANK | OUTCOMES/PAYOUT |

| | | |
|---|---|---|
| A | 439 | −1/LOSS |
| B | 153 | 1 TO 2 |
| C | 32 | 2 TO 1 |
| D | 25 | 3 TO 1 |
| E | 25 | 4 TO 1 |
| F | 2 | 20 TO 1 |
| G | 1 | 50 TO 1 |

TOTAL OF 676, HF = 35%
CA = 4.8%

The processor checks if the two letter “Outcome” of the spin of the first two reels, meets the predetermined condition to automatically activate and spin the third reel and displays a third letter to form a 3 letter “Outcome”. If the predetermined condition is met, then instantly and automatically the third reel will spin and display a third letter. The 3 letter “Outcome” is associated with and determines the fate of the second wager. If the condition is not met, then the processor will credit back to the player a portion of the second wager and all the wagers placed after the second wager, if any, and the game ends. If the predetermined condition for the third reel to spin is to have a chance to get a winning 3 letter “Outcome”, then the processor will use the Libraries and the Ranking system given in FIG. 11 to determine the fate of the second wager. If the pre-determined condition is met, the processor collects and pays the second wager in accordance to the payout schedule given in Table 5 below. The Casino Advantage is 3.9%.

TABLE 5

| | |
|---|---|
| RANKING | OUTCOME/PAYOUT |

| | | |
|---|---|---|
| A + B | 5,035 | −1/LOSS |
| Condition not met | 11,232 | −0.5/half wager loss |
| C | 966 | 3 TO 1 |
| D | 185 | 12 TO 1 |
| E | 125 | 15 TO 1 |
| F | 33 | 60 TO 1 |
| G | 1 | 1000 TO 1 |

TOTAL OF 17576 CA = 3.9%

The process continues until the last placed wager or until the condition is not met.

Table 6 below provides 18 samples runs of a machine with 4 reels, one winning line, 2 or 3 wagers, each wager $1, $3, $5 or $10. When the condition is not met, the machine processor returns 50% of the second wager back to the player. As contemplated from Table 6, players can potentially win a Mini jackpot (when the payout is about 10 to 1), Minor Jackpot (when the payout is about 100 to 1), a Major Jackpot (when the payout is about 1,000 to 1), a Grand Jackpot (when the payout is about 10,000 to 1), and a Super Jackpot (the payout is about 100,000 to 1).

TABLE 6

| | | | | 1^{ST} WAGER | | | |
|---|---|---|---|---|---|---|---|
| SPIN | WAGERS PLACED, $ | | | 2 REELS | | | |
| # | 1ST | 2ND | 3RD | OUTCOME | RANK | FATE | RETURN |
| 1 | 3 | 5 | — | FO | B | WINS 1 TO 2 | $4.50 |
| 2 | 5 | 3 | 3 | BI | C | WINS 2 TO 1 | $15 |
| 3 | 10 | 3 | 1 | BY | F | WINS 20 TO 1 | $210 |
| 4 | 10 | 3 | 5 | SI | G | WINS 50 TO 1 | $510 |
| | | | | MINOR JACKPOT | | | |
| | | | | WINNER | | | |
| 5 | 1 | 5 | — | RO | D | WINS 3 TO 1 | $4 |
| 6 | 3 | 5 | 5 | LO | D | WINS 3 TO 1 | $12 |
| 7 | 1 | 5 | 1 | AI | E | WINS 4 TO 1 | $5 |
| 8 | 5 | 3 | 10 | DO | C | WINS 2 TO 1 | $15 |
| 9 | 3 | 3 | 5 | QU | B | WINS 1 TO 2 | $4.5 |

| | | | | | | |
|---|---|---|---|---|---|---|
| 10 | 1 | 1 | 1 | PL | A | LOSS OF &1 |
| 11 | 5 | 1 | 10 | CL | A | LOSS OF &5 |
| 12 | 1 | 1 | 10 | PL | A | LOSS OF &1 |
| 13 | 5 | 1 | — | PL | A | LOSS OF &5 |
| 14 | 3 | 3 | 3 | PL | A | LOSS OF &3 |
| 15 | 10 | 3 | 3 | FL | A | LOSS OF &10 |
| 16 | 3 | 10 | 10 | SH | A | LOSS OF &3 |
| 17 | 5 | 5 | — | GY | A | LOSS OF &5 |
| 18 | 1 | 10 | 3 | BN | A | LOSS OF &1 |

| | 2^{ND} WAGER | | | | |
|---|---|---|---|---|---|
| SPIN | 3 REELS | | | | |
| # | OUTCOME | RANK | FATE | RETURN | 3^{RD} WAGER |
| 1 | FOY | D | WINS 12 TO 1 | $65 | E—NO WAGER |
| | | | | | PLACED |
| 2 | BIT | C | WINS 4 TO 1 | $15 | BITJ LOSS $3 |
| 3 | BYE | C | WINS 4 TO 1 | $15 | R—CONDITION |
| | | | | | NOT MET $0.5 |
| | | | | | RETURN |
| 4 | SIN | G | WINS 1000 TO 1 | $3003 | SINA RANK G |
| | | | | | $50,005 |
| | | | MAJOR JACKPOT | | SUPER JACKPOT |
| | | | WINNER | | WINNER |
| 5 | ROL | B | LOSS OF $5 | | E—NO WAGER |
| | | | | | PLACED |
| 6 | LOA | B | LOSS OF $5 | | LOAA LOSS $5 |
| 7 | AIZ | B | LOSS OF $5 | | R—CONDITION |
| | | | | | NOT MET $0.5 |
| | | | | | RETURN |
| 8 | DOO | B | LOSS OF $3 | | DOOR WINS C $40 |
| 9 | R—CONDITION | | R $3 CREDITED | | R $5 CREDITED |
| | NOT MET | | BACK | | BACK |
| 10 | PLO | | LOSS OF $1 | | PLOX LOSS OF $1 |
| 11 | CLA | | LOSS OF $1 | | CLAY RANKS |
| | | | | | D $130 |
| 12 | PLX | | LOSS OF $1 | | R—CONDITION |
| | | | | | NOT MET $5 |
| | | | | | RETURN |
| 13 | PLO | | LOSS OF $1 | | E—NO WAGER |
| | | | | | PLACED |
| 14 | PLY | F | WINS 20 TO 1 | $63 | PLYY LOSS OF $3 |
| 15 | FLU | D | WINS 12 TO 1 | $39 | FLUE RANKS D $39 |
| 16 | SHY | F | WINS 100 TO 1 | $1010 | R—CONDITION |
| | | | | | NOT MET $5 |
| | | | | | RETURN |
| 17 | GYM | F | WINS 100 TO 1 | $505 | E—NO WAGER |
| | | | | | PLACED |

| | | | |
|---|---|---|---|
| 18 | R—CONDITION | R $10 CREDITED | R $3 CREDITED |
| | NOT MET | BACK | BACK |

What is claimed is:

1. A deck of playing cards, comprising:
a single or a plurality of sub-decks of cards, each sub-deck including C cards, each card having a face side that bears a different letter of a language alphabet.

2. The deck of claim 1, wherein C is 26 and each card having a face side that bears a different letter of the English alphabet, including 21 consonants and 5 vowels.

3. The deck of claim 1, further comprising one or more wild cards.

4. A gaming apparatus, comprising:
a data processor implementing a random number generator;
a database storing libraries with a plurality of sets, each set comprising of C letters of an alphabet;
a user-operable keypad to input a user's choice of a unique combination or permutation of letters;
a user-operable trigger causing the data processor to randomly select and display in sequence one or more of the letters to form an outcome; and
wherein all the letters have an equal chance to be selected and displayed.

5. The apparatus of claim 4, wherein C is 26 representing the English alphabet including 21 consonants and 5 vowels.

6. The apparatus of claim 4, further comprising one or more wild letters.
